(19) United States
(12) Patent Application Publication
(10) Pub. No.: US 2006/0072834 A1
(43) Pub. Date: Apr. 6, 2006

(54) Permutation procrastination

(76) Inventors: William C. Lynch, Palo Alto, CA (US); Steven E. Saunders, Cupertino, CA (US); Krasimir D. Kolarov, Menlo Park, CA (US)

Correspondence Address: GREENBERG TRAURIG, LLP, 1900 UNIVERSITY AVENUE, FIFTH FLOOR, EAST PALO ALTO, CA, 94303, US

(21) Appl. No.: 11/232,725

(22) Filed: Sep. 21, 2005

Related U.S. Application Data
(63) Continuation-in-part of application No. 10/944,437, filed on Sep. 16, 2004.
(63) Continuation-in-part of application No. 10/418,649, filed on Apr. 17, 2003.
(63) Continuation-in-part of application No. 10/418,363, filed on Apr. 17, 2003.
(63) Continuation-in-part of application No. 10/447,455, filed on May 28, 2003.
(63) Continuation-in-part of application No. 10/447,514, filed on May 28, 2003.
(63) Continuation-in-part of application No. 10/955,240, filed on Sep. 29, 2004.
(60) Provisional application No. 60/612,311, filed on Sep. 21, 2004.
(60) Provisional application No. 60/612,652, filed on Sep. 22, 2004.
(60) Provisional application No. 60/612,651, filed on Sep. 22, 2004.
(60) Provisional application No. 60/618,558, filed on Oct. 12, 2004.
(60) Provisional application No. 60/618,938, filed on Oct. 13, 2004.
(60) Provisional application No. 60/654,058, filed on Feb. 16, 2005.

(51) Int. Cl. G06K 9/36

(52) U.S. Cl. 382/232

(57) ABSTRACT

A system and method by which multiple run-of-zeros elimination (ROZE) data areas, or other compressed data, can be restored to a single dense data array with simple address computation, even when the simple addressing puts the data into non-final, permuted locations. The data is rearranged in a subsequent computational step with no net cost to the algorithm.

### RELATED APPLICATIONS

The present application claims priority from provisional applications filed Sep. 21, 2004 under U.S. Patent Application No. 60/612,311 entitled RATE CONTROL WITH VARIABLE SUBBAND QUANTIZATION; filed Sep. 22, 2004 under U.S. Patent Application No. 60/612,652 entitled SPLIT TABLE ENTROPY CODING; filed Sep. 22, 2004 under U.S. Patent Application No. 60/612,651 entitled PERMUTATION PROCRASTINATION; filed Oct. 12, 2004 under U.S. Patent Application No. 60/618,558 entitled MOBILE IMAGING APPLICATION, DEVICE ARCHITECTURE, AND SERVICE PLATFORM ARCHITECTURE; filed Oct. 13, 2004 under U.S. Patent Application No. 60/618,938 entitled VIDEO MONITORING APPLICATION, DEVICE ARCHITECTURES, AND SYSTEM ARCHITECTURE; filed Feb. 16, 2005 under U.S. Patent Application No. 60/654,058 entitled MOBILE IMAGING APPLICATION, DEVICE ARCHITECTURE, AND SERVICE PLATFORM ARCHITECTURE AND SERVICES; each of which is incorporated herein by reference in its entirety.

The present application is a continuation-in-part of U.S. patent application Ser. No. 10/944,437 filed Sep. 16, 2004 entitled MULTIPLE CODEC-IMAGER SYSTEM AND METHOD, now U.S. Publication No. US2005/0104752 published on May 19, 2005; continuation-in-part of U.S. patent application Ser. No. 10/418,649 filed Apr. 17, 2003 entitled SYSTEM, METHOD AND COMPUTER PROGRAM PRODUCT FOR IMAGE AND VIDEO TRANSCODING, now U.S. Publication No. US2003/0206597 published on Nov. 6, 2003; continuation-in-part of U.S. patent application Ser. No. 10/418,363 filed Apr. 17, 2003 entitled WAVELET TRANSFORM SYSTEM, METHOD AND COMPUTER PROGRAM PRODUCT, now U.S. Publication No. US2003/0198395 published on Oct. 23, 2003; continuation-in-part of U.S. patent application Ser. No. 10/447,455 filed on May 28, 2003 entitled PILE-PROCESSING SYSTEM AND METHOD FOR PARALLEL PROCESSORS, now U.S. Publication No. US2003/0229773 published on Dec. 11, 2003; continuation-in-part of U.S. patent application Ser. No. 10/447,514 filed on May 28, 2003 entitled CHROMA TEMPORAL RATE REDUCTION AND HIGH-QUALITY PAUSE SYSTEM AND METHOD, now U.S. Publication No. US2003/0235340 published on Dec. 25, 2003; continuation-in-part of U.S. patent application Ser. No. 10/955,240 filed Sep. 29, 2004 entitled SYSTEM AND METHOD FOR TEMPORAL OUT-OF-ORDER COMPRESSION AND MULTI-SOURCE COMPRESSION RATE CONTROL, now U.S. Publication No. US2005/0105609 published on May 19, 2005; continuation-in-part of U.S. Application No. ______ filed Sep. 20, 2005 entitled COMPRESSION RATE CONTROL SYSTEM AND METHOD WITH VARIABLE SUBBAND PROCESSING (Attorney Docket No. 74189-200301/US); each of which is incorporated herein by reference in its entirety. This application also incorporates by reference in its entirety U.S. Pat. No. 6,825,780 issued on Nov. 30, 2004 entitled MULTIPLE CODEC-IMAGER SYSTEM AND METHOD; U.S. Pat. No. 6,847,317 issued on Jan. 25, 2005 entitled SYSTEM AND METHOD FOR A DYADIC-MONOTONIC (DM) CODEC; and U.S. Application No. ______ filed Sep. 21, 2005 entitled MULTIPLE TECHNIQUE ENTROPY CODING SYSTEM AND METHOD (Attorney Docket No. 74189-200401/US).

### FIELD OF THE INVENTION

The present invention relates to data compression, and more particularly to changes in the ordering of data that is being transferred between various stages of the data compression.

### BACKGROUND OF THE INVENTION

Directly digitized still images and video requires many “bits”. Accordingly, it is common to compress images and video for storage, transmission, and other uses. Most image and video compressors share a basic architecture, with variations. The basic architecture has three stages: a transform stage, a quantization stage, and an entropy coding stage, as shown in FIG. 1.

Video “codecs” (compressor/decompressor) are used to reduce the data rate required for data communication streams by balancing between image quality, processor requirements (i.e. cost/power consumption), and compression ratio (i.e. resulting data rate). The currently available compression approaches offer a different range of trade-offs, and spawn a plurality of codec profiles, where each profile is optimized to meet the needs of a particular application.

The intent of the transform stage in a video compressor is to gather the energy or information of the source picture into as compact a form as possible by taking advantage of local similarities and patterns in the picture or sequence. Compressors are designed to work well on “typical” inputs and ignore their failure to compress “random” or “pathological” inputs.

Many image compression and video compression methods, such as MPEG-2, use the discrete cosine transform (DCT) as the transform stage.

Some newer image compression and video compression methods, such as MPEG-4 textures, use various wavelet transforms as the transform stage.

A wavelet transform comprises the repeated application of wavelet filter pairs to a set of data, either in one dimension or in more than one. For image compression, a 2D wavelet transform (horizontal and vertical) can be used. For video data streams, a 3D wavelet transform (horizontal, vertical, and temporal) can be used.

Prior Art FIG. 2 shows an example 100 of trade-offs among the various compression algorithms currently available. As shown, such compression algorithms include wavelet-based codecs 102, and DCT-based codecs 104 that include the various MPEG video distribution profiles.

2D and 3D wavelets, as opposed to DCT-based codec algorithms, have been highly regarded due to their pleasing image quality and flexible compression ratios, prompting the JPEG committee to adopt a wavelet algorithm for its JPEG2000 still image standard. Unfortunately, most wavelet implementations use very complex algorithms, requiring a great deal of processing power, relative to DCT alternatives. In addition, wavelets present unique challenges for temporal compression, making 3D wavelets particularly difficult.

For these reasons, wavelets have never offered a cost-competitive advantage over high volume industry standard codecs like MPEG, and have therefore only been adopted for niche applications. There is thus a need for a commercially viable implementation of 3D wavelets that is optimized for low power and low cost focusing on three major market segments.

For example, small video cameras are becoming more widespread, and the advantages of handling their signals digitally are obvious. For instance, the fastest-growing segment of the cellular phone market in some countries is for phones with image and video-clip capability. Most digital still cameras have a video-clip feature. In the mobile wireless handset market, transmission of these still pictures and short video clips demand even more capacity from the device battery. Existing video coding standards and digital signal processors put even more strain on the battery.

Another new application is the Personal Video Recorders (PVR) that allow a viewer to pause live TV and time-shift programming. These devices use digital hard disk storage to record the video, and require video compression of analog video from a cable. In order to offer such features as picture-in-picture and watch-while-record, these units require multiple video compression encoders.

Another growing application area is the Digital Video Recorders (DVR) for surveillance and security video. Again, compression encoding is required for each channel of input video to be stored. In order to take advantage of convenient, flexible digital network transmission architectures, the video often is digitized at the camera. Even with the older multiplexing recorder architecture, multiple channel compression encoders are used.

Of course, there are a vast number of other markets which would benefit from a commercially viable compression scheme that is optimized for low power and low cost.

Temporal Compression

Video compression methods normally do more than compress each image of the video sequence separately. Images in a video sequence are often similar to the other images in the sequence nearby in time. Compression can be improved by taking this similarity into account. Doing so is called “temporal compression”. One conventional method of temporal compression, used in MPEG, is motion search. In this method, each region of an image being compressed is used as a pattern to search a range in a previous image. The closest match is chosen, and the region is represented by compressing only its difference from that match.

Another method of temporal compression is to use wavelets, just as in the spatial (horizontal and vertical) directions, but now operating on corresponding pixels or coefficients of two or more images. This is called 3D wavelets, for the three “directions” horizontal, vertical, and temporal.

Temporal compression, by either method or any other, compresses an image and a previous image together. In general, a number of images is compressed together temporally. This set of images is called a Group of Pictures or GOP.

Many wavelet compression techniques, as well as other compression techniques, divide the original image into blocks and transform each block separately. In some transforms relating to the present invention, the result of a transform performed on a block is data comprising multiple subbands. The various subbands typically have very different statistical properties therefore it is frequently desirable to keep them separate for later disparate processing. Additionally, to facilitate later processing, subbands containing data that is statistically similar are often grouped together in later processing. As a consequence data that was in order (or adjacent position) within the result of the transform, is frequently stored out of order (or in separated positions) by the operation of subsequent operations in the compression technique applied (such as by the grouping of subbands by statistical similarity.

Run-of-Zeros Elimination (ROZE)

Many compression methods have one or more steps that change the representation of some data from a “dense” representation where every value is explicitly present, to a “sparse” representation where zero values are not explicitly present but are represented implicitly in some way. An example of a dense-to-sparse transformation is a “run-of-zeros elimination” (ROZE) or run-coding. This is typically done when a body of data is expected to have many zero values, so that it is more compact to represent the zeros by counting them and recording the number of adjacent zeros rather than listing each zero individually.

When ROZE data is encountered in the decoding of such compressed data, the inverse transformation is needed: the ROZE data is used to fill in an array with all of the zeros and other values explicitly present for further processing.

Doing these processes efficiently on a parallel processor, or in other specialized implementation platforms, can require that parts of the same data array be transformed into several distinct ROZE areas each representing a portion of the data (for example, each ROZE area may represent a subband of a transformed image). The parts that are separated this way can be interleaved in memory.

Run-of-zeros elimination can be implemented by “piling”, as described in co-pending U.S. patent application Ser. No. 10/447,455, Publication No. 2003/0229773, incorporated herein by reference.

Undoing ROZE

When decoding or expanding an array of data that has been processed and stored into a ROZE area, the zeros can be generated one at a time while counting out the run lengths. Alternatively, the entire target area can be “zeroed”, and then the non-zero values can be inserted by simply skipping from one nonzero value in the data to the next. This can be accomplished by using the run length to increment an address or pointer in the memory addresses as each non-zero value is added to the memory. In many computing architectures setting an area of memory to zero is especially efficient, so the alternative method just described is advantageous. An example procedure, which may be termed linear expansion, is as follows:

Step 1.

Initialize an address A to the start of the dense array. (By dense array is meant one in which substantially every, or every, element of the data is explicitly represented in its order).

Initialize the dense array to contain all zero values.

Step 2.

If any ROZE data remain, get the next zero run length L; increment A by L. Otherwise, end.

Step 3.

Get the next nonzero data item from the ROZE area and deposit it at the address A.

Go to Step 2.

The above example procedure, however, is primarily effective in instances where the dense array is a single contiguous range (i.e., not containing gaps in the address range) of memory.

When the data for an array has been transformed into several ROZE areas rather than a single one, the calculation of the address A can become very complex; the simple step above “increment A by L” is no longer sufficient. Instead the address calculation must be accomplished by other means that take into account the gaps in the address sequence. This address calculation can slow down the expanding process (i.e. the undoing ROZE step) by a factor of two or three or more. This slowdown can be significant on a non-parallel processing platform, and can become even more significant when the expansion is done on a parallel processing platform.

Accordingly, in certain designs of compression processes the data is compressed or processed to a representation from which a linear expansion will result in an array containing a restoration of the original data (or an approximation of the original data) but in which the order of data items does not match the order of the data items in the original array. To expand the compressed data to a condition in which its order does match the original has heretofore required computationally expensive processes. Certain aspects of the present invention, however, provide a highly efficient computational method for expanding the compressed data into its original order. In fact, it can do so by using the highly efficient techniques of linear expansion as major components of the operation.

### BRIEF DESCRIPTION OF FIGURES

FIG. 1 illustrates a framework for compressing/decompressing data, in accordance with one embodiment.

FIG. 2 shows an example of trade-offs among the various compression algorithms currently available.

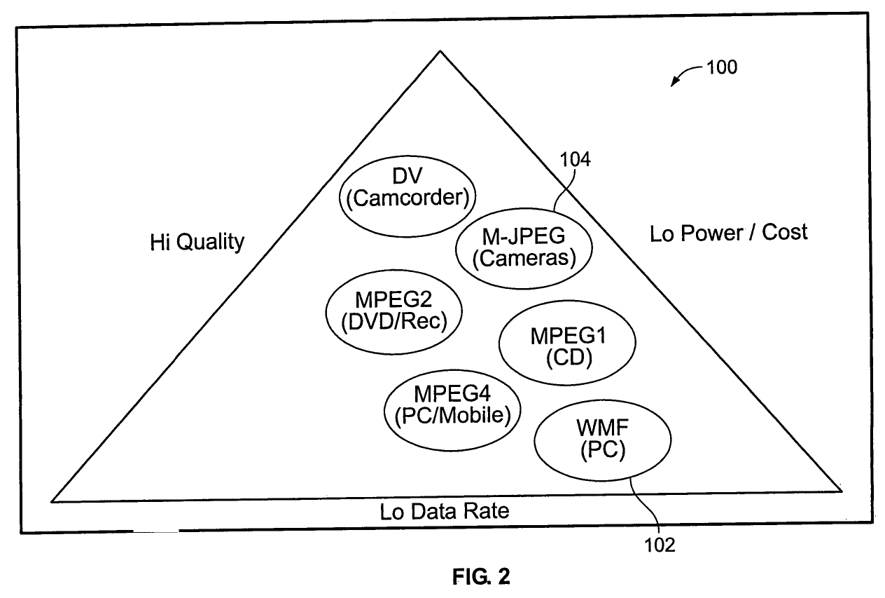

### DESCRIPTION OF THE PREFERRED EMBODIMENTS

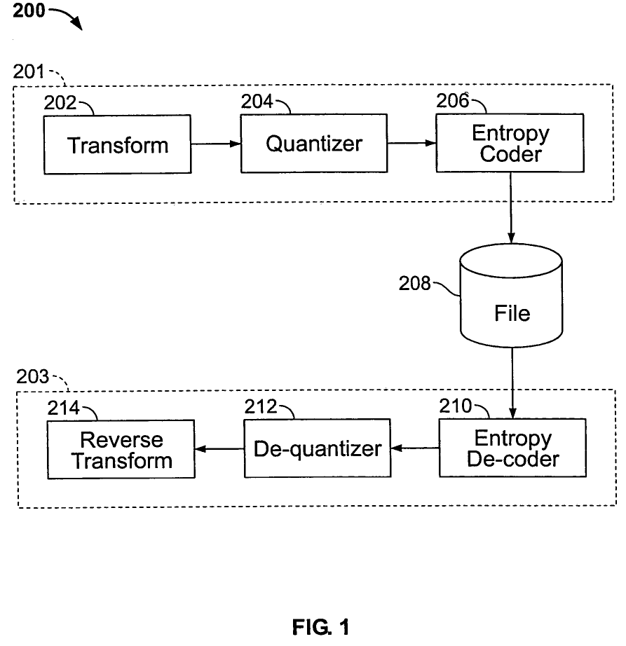

FIG. 1 illustrates a framework 200 for compressing/decompressing data, in accordance with one embodiment. Included in this framework 200 are a coder portion 201 and a decoder portion 203, which together form a “codec.” The coder portion 201 includes a transform module 202, a quantizer 204, and an entropy encoder 206 for compressing data for storage in a file 208. To carry out decompression of such file 208, the decoder portion 203 includes an entropy decoder 210, a de-quantizer 212, and a inverse transform module 214 for decompressing data for use (i.e. viewing in the case of video data, etc). In use, the transform module 202 carries out a reversible transform of a plurality of pixels (in the case of video data) for the purpose of de-correlation. Next, the quantizer 204 effects the quantization of the transform values, after which the entropy encoder 206 is responsible for entropy coding of the quantized transform coefficients.

We can overcome the difficulty described in the Background of the invention by undoing the ROZE data into the array using the simple method above (i.e., linear expansion) for each ROZE area, one at a time, skipping the “initialize A” operation for all but the first ROZE area. The expansion yields the correct nonzero values and the correct number of zero values, but they are located in the wrong addresses within the dense array. The relation between the correct addresses for each data item and the addresses resulting from the simplified operation is a “permutation”.

Fortunately, in some algorithms, the operation following the step of undoing ROZE works “point-wise” (i.e., item-by-item) and is not sensitive to the order or location of the items. When this is the case, we can proceed to the next step without first rearranging the data into the correct locations, since their locations do not matter for that step.

A practical example of such a step is “inverse quantization”, a well-known step in image or video decompression that multiplies each data item by a known factor to restore it to the correct magnitude range for further computation. Such a step can occur in between de-quantizer 212 and inverse transform 214 of decoder 203, shown in FIG. 1.

Another practical example of such a step is a temporal inverse wavelet filter operation. In this case, two data items are combined, but the two data items come from corresponding positions in successive images of the GOP, which have been rearranged in the same way by undoing ROZE on each. Therefore, the inputs to the temporal inverse wavelet filter are at the same locations relative to each other, and can be processed in any order.

Now the operation of rearranging the data into the correct locations can be combined with the location-independent processing as described below. Notice that the rearranging is being done “for free”, since no extra data fetches and stores are being done; only the addresses are different, and they can be completely predetermined, at compile time or chip design time.

The address sequence for fetching and storing the data is generated in this way. Consider the dense array; for each location, the data there belongs in some (possibly different) location of the array. This defines a “permutation” of the array addresses. It is well known that every permutation can be decomposed or factored into “cycles”, that is, permutations that begin and end with the same location. Any location that has the data really belonging there is a cycle of length 1. Any pair of locations that have each other's data form a cycle of length 2; and so on.

So, according to certain aspects of portions of the present invention, assuming we know the permutation, we can provide the complete set of cycles of the permutation and use the complete set of cycles as follows:

Algorithm 1

Step 1.

Choose a cycle that has not yet been traversed. If none remain, stop.

Step 2.

Fetch the data from the first location in this cycle. Do the computation step on this data, and call the result R.

If this cycle is of length 1, store R into the address and go to Step 1.

Step 3.

If the cycle has been completed, go to Step 4.

Otherwise, fetch the data from the next location in this cycle.

Store R into the current (just fetched) location.

Do the computation step on this (just fetched) data, and call the result R.

Go to Step 3.

Step 4.

Store R into the first location of the cycle. Go to Step 1.

Accordingly, it can be seen that the inventive process illustrated in Algorithm 1 operates using a representation of the permutation in terms of cycles. For each cycle it

Unrolling

Algorithm 1 has several tests and branch points. These can reduce the execution efficiency of many computing engines.

Note that the choosing in Step 1 and the testing in Step 2 and Step 3 can be done once and for all when the program is compiled or the chip layout is generated, so that the program is in a “straight line” form and execution time is not spent doing these tests. An alternative way of viewing the predetermination is to treat the Algorithm 1 above as a compile time operation, where the Fetch, Store, and Compute operations generate code to be executed at run time. These considerations lead to Algorithm 2 which illustrates and represents an additional aspect of the present invention having improved computational efficiency over Algorithm 1:

Algorithm 2 (compiling)

Step 1.

Choose a cycle that has not yet been traversed. If none remain, stop.

Step 2.

Generate code to fetch the data from the first location in this cycle. Generate code to do the computation step on this data, and call the result R.

If this cycle is of length 1, generate code to store R into the address and go to Step 1.

Step 3.

If the cycle has been completed, go to Step 4.

Otherwise, generate code to fetch the data from the next location in this cycle. Generate code to store R into the current (just fetched) location. Generate code to do the computation step on this (just fetched) data, and call the result R.

Go to Step 3.

Step 4.

Generate code to store R into the first location of the cycle. Go to Step 1.

Algorithm 2 generates straight-line code with no tests and no branches. This kind of code is the most efficient to execute on processors, especially those with parallel operations such as pipelines.

Accordingly, it can be seen that Algorithm 2 will serve to create a straight line program on the basis of the known characteristics of the particular permutation presented. The straight line program when operated will fetch, process (including processes such as reverse quantizing or inverse temporal transforming) and store the expanded data in the correct order as determined by the permutation cycles.

Other run-coding methods exist that count other values besides zeros, too. The methods described above can be readily extended to operate with such methods.

Algorithms 1 and 2 apply equally well to data that is scrambled in memory in a predetermined way for any reason, not just by undoing ROZE. For instance, the diagonal scan of an MPEG block is such a scrambling. Whenever such scrambled data is to be operated on in “point-wise” fashion, we can combine the unscrambling with the point-wise operation as shown here with savings in computation time.

Algorithms 1 and 2 apply equally well to situations with multiple sets of data that are scrambled by the identical permutation. To compute on these data sets in parallel, each step of either algorithm should fetch, compute, or store data from each of the data sets using the same relative address in each. This works whether the computations are independent of each other, or involve a combination of the corresponding data items from some or all of the data sets.

According to one aspect, the present invention provides a method by which multiple ROZE data areas can be restored to a single dense data array with simple address computation, even when the simple addressing puts the data into non-final, permuted locations. The data is rearranged in a subsequent computational step with no net cost to the algorithm.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A method of storing digital image data in a data array, comprising:
receiving digital image data in an original ordered sequence relative to the underlying image;
storing the data a first time in addresses of a data array, the addresses having a permuted sequence relative to the original ordered sequence of the data;
retrieving the stored data from the data array;
performing at least one operation on the retrieved data; and
storing the data a subsequent time in the addresses of the data array, wherein during the subsequent storing step the data is stored in addresses having the original ordered sequence.
